(19) United States
(12) Patent Application Publication
(10) Pub. No.: US 2016/0369697 A1
(43) Pub. Date: Dec. 22, 2016

(54) COOLED COOLING AIR SYSTEM FOR A TURBOFAN ENGINE

(71) Applicant: United Technologies Corporation, Hartford, CT (US)

(72) Inventors: Frederick M. Schwarz, Glastonbury, CT (US); Paul W. Duesler, Manchester, CT (US)

(21) Appl. No.: 14/740,368

(22) Filed: Jun. 16, 2015

(51) Int. Cl. F02C 7/18; F01P 11/12; F01P 7/02

(52) U.S. Cl. CPC F02C 7/185; F01P 7/02; F01P 11/12

(57) ABSTRACT

A gas turbine engine includes an engine core defining a primary flowpath, and a nacelle radially surrounding the engine core. The nacelle includes at least one bifurcation, and a cooled cooling air system including a heat exchanger. The heat exchanger is disposed at least partially in the bifurcation

### TECHNICAL FIELD

The present disclosure relates generally to turbofan engines, and more specifically to a cooled cooling air system for utilization within a turbofan engine.

### BACKGROUND

Gas turbine engines, such as those utilized on commercial aircraft, typically include a compressor section that draws in and compresses air, a combustor section where the compressed air is mixed with a fuel and ignited, and a turbine section across which the combustion gasses from the ignition are expanded. Expansion of the combustion gasses across the turbine section drives rotation of the turbine section, which in turn drives rotation of the compressor section. Each of the compressor section, the combustor section, and the turbine section are contained within an engine core, and are connected by a primary flowpath that flows through each of the sections.

Fore of the compressor section is a fan that drives air through a fan bypass duct surrounding the engine core. As with the compressors, the fan is connected to the turbine section via a drive shaft. In some example engines, the fan is connected through a gear system, and the engine is referred to as a geared turbofan engine. In alternative engines, the fan is connected directly to a turbine in the turbine section via a drive shaft and the engine is referred to as a direct drive engine.

In order to cool some components of the engine, cooling air is provided from a cooling air system directly to the cooled components. In order to provide more efficient cooling, the cooling air in some examples is actively cooled. A system for actively cooling the cooling air is referred to as a cooled cooling air system.

### SUMMARY OF THE INVENTION

In one exemplary embodiment, a gas turbine engine includes an engine core defining a primary flowpath, and a nacelle radially surrounding the engine core. The nacelle includes at least one bifurcation, and a cooled cooling air system including a heat exchanger. The heat exchanger is disposed at least partially in the bifurcation.

In another exemplary embodiment of the above described gas turbine engine, the bifurcation is a lower bifurcation.

In another exemplary embodiment of any of the above described gas turbine engines, the heat exchanger is structurally mounted to the engine core via at least one bracket.

In another exemplary embodiment of any of the above described gas turbine engines, the heat exchanger is an air-air heat exchanger, and a cooling air stream originates in a fan bypass duct.

In another exemplary embodiment of any of the above described gas turbine engines, the cooling air stream exhausts into one of an aft portion of the fan bypass duct and an ambient atmosphere downstream of the fan bypass duct.

In another exemplary embodiment of any of the above described gas turbine engines, a spent cooling air exhaust nozzle is a thrust producing nozzle.

In another exemplary embodiment of any of the above described gas turbine engines, the heat exchanger is an orthoganol heat exchanger.

Another exemplary embodiment of any of the above described gas turbine engines, further includes a fan fore of the engine core, and wherein the fan is connected to the engine core via a gearing system.

In another exemplary embodiment of any of the above described gas turbine engines the cooled cooling air system includes a second heat exchanger, and wherein the second heat exchanger is at least partially disposed in the bifurcation.

In another exemplary embodiment of any of the above described gas turbine engines the cooled cooling air system further includes a cooling air inlet door, the cooling air inlet door including a flow regulation feature.

In another exemplary embodiment of any of the above described gas turbine engines the flow regulation feature is an articulating door controllably coupled to an engine controller such that the engine controller is operable to control a flow of air through the cooling air inlet.

In another exemplary embodiment of any of the above described gas turbine engines the cooled cooling air system further includes a cooling air outlet door, the cooling air outlet door including a flow regulation feature.

In another exemplary embodiment of any of the above described gas turbine engines the flow regulation feature is an articulating door, and the articulating door is controllably coupled to an engine controller such that the engine controller is operable to control a flow of air through the cooling air outlet.

An exemplary method for generating cooled cooling air in a gas turbine engine includes withdrawing fan bypass duct air from a fan bypass duct and withdrawing bleed air from a primary flowpath in an engine core, providing the fan bypass air and the bleed air to a heat exchanger in an engine bifurcation via ducting, transferring heat from the bleed air to the fan bypass air in the heat exchanger, and providing the cooled bleed air to at least one gas turbine engine component as cooled cooling air.

A further example of the above exemplary method includes withdrawing fan bypass duct air from a fan bypass duct including modifying a position of at least one articulating door at one of an inlet of the ducting and an outlet of the ducting.

A further example of any of the above exemplary methods further includes exhausting heated fan bypass duct air from the heat exchanger into one of an aft portion of the fan bypass duct and an ambient atmosphere downstream of the fan bypass duct.

In a further example of any of the above exemplary methods includes exhausting the heated fan bypass duct air includes passing the heated fan bypass air through an exhaust nozzle, thereby generating thrust.

In a further example of any of the above exemplary methods includes transferring heat from the bleed air to the fan bypass air in the heat exchanger comprises passing the bleed air through a plurality of pipes in the heat exchanger, and passing the fan bypass air across the pipes in the heat exchanger.

In a further example of any of the above exemplary methods includes providing the fan bypass air and the bleed air to a heat exchanger in an engine bifurcation via ducting further comprises providing the fan bypass air and the bleed air to at least two heat exchangers in the engine bifurcation.

These and other features of the present invention can be best understood from the following specification and drawings, the following of which is a brief description.

### BRIEF DESCRIPTION OF THE DRAWINGS

FIG. 1 schematically illustrates an exemplary gas turbine engine.

FIG. 2 schematically illustrates a front view of a gas turbine engine.

FIG. 3 schematically illustrates a cross section view of a fan nacelle at a bifurcation.

FIG. 4 schematically illustrates a cross sectional view of an alternate fan nacelle at a bifurcation.

### DETAILED DESCRIPTION OF AN EMBODIMENT

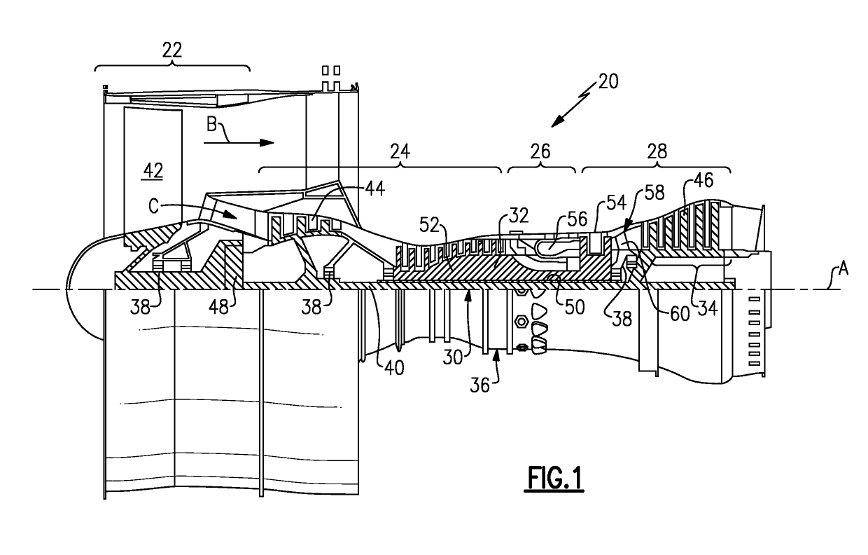

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (1066.8 meters). The flight condition of 0.8 Mach and 35,000 ft (1066.8 m), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]̂0.5. The “Low corrected fan tip speed” as disclosed herein according to one non-limiting embodiment is less than about 1150 ft/second (350.5 m/s).

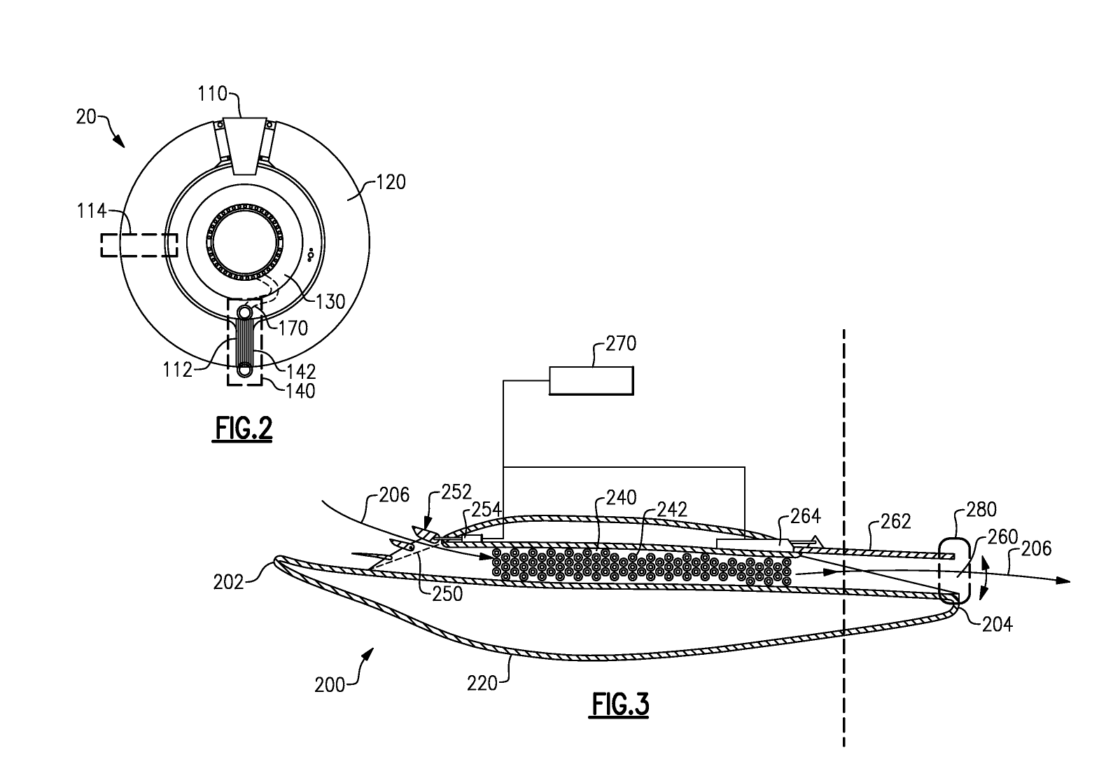

With continued reference to FIG. 1, FIG. 2 schematically illustrates a front view of the gas turbine engine 20. The engine core 130 is contained within a fan nacelle 120, and a fan bypass duct is defined between the fan nacelle 120 and the engine core 130. The fan nacelle 120 includes a pylon mount 110 for mounting the engine 20 to a wing of an aircraft.

In order to allow access to the engine core 130, as well as other internal components of the gas turbine engine 20, the fan nacelle 120 includes a bifurcation 112. The bifurcation 112 is approximately 180 degrees offset from the pylon mount 110 and is referred to as a lower bifurcation. Alternative engines can include additional bifurcations, or position the bifurcation at a different location. By way of example, some engines can include a bifurcation at position 114. The alternative engines can include the bifurcation in any other suitable position. The cooled cooling air is provided to one or more components in the engine 20 and actively cools the component.

During operation of the gas turbine engine 20, components, such as a last stage of the compressor section, are exposed to extreme temperatures. By way of example, the excess power draw required during take-off and ascent to cursing altitude can cause the engine 20 to generate high amounts of heat. In order to cool some sections of the engine 20, a cooled cooling air system 140 is included in the engine 20. The cooled cooling air system 140 uses one or more heat exchangers 142 to cool bleed air from the primary flowpath through the engine core 130, and provides the cooled bleed air (referred to as cooled cooling air) to components in need of cooling within the gas turbine engine 20. The cooled cooling air is used to cool the engine components according to known cooling principles. The cooled cooling air system 140 uses air drawn from the fan bypass duct as a heat sink for the cooled cooling air in the heat exchanger 142.

The heat exchanger 142 in the illustrated example of FIG. 2 is disposed completely within the lower bifurcation 112. In alternative examples, the heat exchanger can be partially disposed in a bifurcation 112, 140, with a remainder being housed within the fan nacelle 120. The heat exchanger 142 is structurally mounted to the engine core 130 via a mechanical bracket 170, or other mechanical bracketing system.

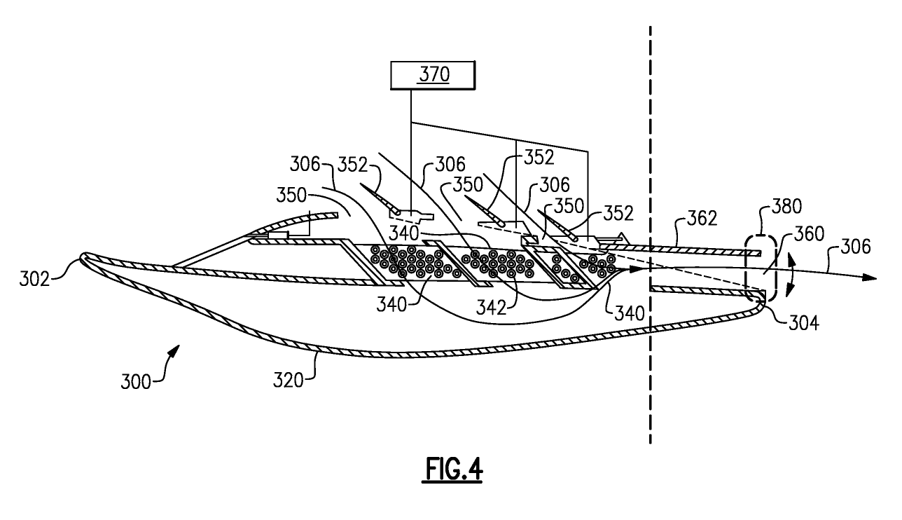

With continued reference to FIG. 2, and with like numerals indicating like elements, FIG. 3 schematically illustrates a cross section of a bifurcation including a cooled cooling air system, such as the cooled cooling air system 140 of FIG. 2. The cross sectional view 200 illustrates a leading edge 202 of the fan nacelle 220 through to a trailing edge 204 of the fan nacelle 220. A heat exchanger 240, which is part of the cooled cooling air system 140 is included within the bifurcation.

Upstream of the heat exchanger 240 is an inlet 250 that allows an air stream 206 into the heat sink portion of the heat exchanger 240. The air stream 206 is a portion of the air that enters the bypass fan duct. As the air stream 206 passes through the heat exchanger 240, cooling air drawn from a bleed within the engine core passes through multiple pipes 242 within the heat exchanger 240, and heat is transferred from the bleed air into the air stream 206.

The heated air within the air stream 206 is referred to as spent air, and is exhausted from the heat exchanger 240, and the cooled cooling air system, via a spent air outlet 260. In some examples the spent air outlet 260 is downstream of a fan duct nozzle into ambient atmosphere. In alternative examples, the spent air outlet can be upstream of the fan duct nozzle and is added back to the air in the fan duct prior to the fan duct air passing through the nozzle.

Each of the inlet 250 and the outlet 260 can include a flow regulation feature, such as articulating doors 252, 262. The flow regulation feature is able to control the flow of air through the inlet 252 or outlet 260, and therefore control the flow of heat sink air in the air stream 206 and through the heat exchanger 240.

In the illustrated example, each of the articulating doors 252, 262 is controllably coupled to an engine controller 270, and the engine controller 270 controls the articulation of the doors 252, 262. In such an example, the articulating doors 252, 262 can be controlled by actuators 254, 264 that are in turn controlled by the engine controller 270. Alternatively, any other means of opening and closing the doors 252, 262 can be utilized in place of the illustrated actuators 254, 264. Further, in some examples, the outlet 260 can be shaped and constricted to function as a nozzle 280 and generate thrust, such an outlet is referred to as a thrust producing nozzle. In such an example, the thrust generated by the nozzle 280 reclaims a portion of the thrust lost when air is removed from the fan bypass duct to enter the air stream 206. In alternative examples, the doors 252, 262 can be included at only the inlet 250 or the outlet 260.

With continued reference to FIGS. 2 and 3, FIG. 4 schematically illustrates cross sectional view 300 of an alternate fan nacelle at a bifurcation. The fan nacelle of FIG. 4 is similar in construction to the fan nacelle of FIG. 3, with a leading edge 302, a trailing edge 304, and a cooled cooling air system including a heat exchanger 340 positioned in the bifurcation. Unlike the example of FIG. 3, however, the example of FIG. 4 includes multiple heat exchangers 340, each of which includes multiple pipes 342 carrying bleed air. Each of the heat exchangers 340 includes a corresponding inlet 350 that allows air from the fan bypass duct to enter the heat exchanger as the air stream 306 and operate as the heat sink for the bleed air passing through the pipes 342. As the air stream 306 exits each of the heat exchangers 340, the airstreams are merged into a single airstream that is then passed out of an outlet 360.

As with the example of FIG. 3, each of the inlets 350, and the outlet 360 include airflow regulation features, such as articulating doors 352, 362, that are capable of restricting or regulating the flow of air from the fan bypass duct into or out of the heat exchangers 340. The illustrated articulating doors 353, 363 are controlled by an engine controller 370. In some examples, each of the articulating doors at the inlets 350 can be controlled simultaneously as a single unit. In alternative examples, the controller 370 can control the articulating doors 352 independently of each other, allowing airflow through each of the heat exchangers 340 to be controlled independently of the airflow through the other heat exchangers 340.

The articulating door 362 at the outlet can be arranged to form a nozzle 380, and reclaim thrust in the same manner as the articulating door 262 illustrated in FIG. 2, and described above.

In each of the above described examples, the heat exchangers 240, 340 are described and illustrated as orthogonal heat exchangers. One of skill in the art, having the benefit of this disclosure will further understand that alternative air-air heat exchangers could be utilized in place of the illustrated and described orthogonal heat exchangers 240, 340, without significant modification to the above described features.

Further, one of skill in the art having the benefit of this disclosure, will understand that multiple cooled cooling air systems can be included within a single engine, with a heat exchanger of each cooled cooling air system being included within one of the bifurcations 112, 114.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
an engine core defining a primary flowpath;
a nacelle radially surrounding the engine core;
the nacelle including at least one bifurcation; and
a cooled cooling air system including a heat exchanger, the heat exchanger being disposed at least partially in the bifurcation.

2. The gas turbine engine of claim 1, wherein the bifurcation is a lower bifurcation.

3. The gas turbine engine of claim 1, wherein the heat exchanger is structurally mounted to the engine core via at least one bracket.

4. The gas turbine engine of claim 1, wherein the heat exchanger is an air-air heat exchanger, and a cooling air stream originates in a fan bypass duct.

5. The gas turbine engine of claim 4, wherein the cooling air stream exhausts into one of an aft portion of the fan bypass duct and an ambient atmosphere downstream of said fan bypass duct.

6. The gas turbine engine of claim 1, wherein a spent cooling air exhaust nozzle is a thrust producing nozzle.

7. The gas turbine engine of claim 1, wherein the heat exchanger is an orthoganol heat exchanger.

8. The gas turbine engine of claim 1, further comprising a fan fore of said engine core, and wherein said fan is connected to said engine core via a gearing system.

9. The gas turbine engine of claim 1, wherein said cooled cooling air system includes a second heat exchanger, and wherein said second heat exchanger is at least partially disposed in the bifurcation.

10. The gas turbine engine of claim 1, wherein the cooled cooling air system further includes a cooling air inlet door, the cooling air inlet door including a flow regulation feature.

11. The gas turbine engine of claim 10, wherein the flow regulation feature is an articulating door controllably coupled to an engine controller such that the engine controller is operable to control a flow of air through said cooling air inlet.

12. The gas turbine engine of claim 1, wherein the cooled cooling air system further includes a cooling air outlet door, the cooling air outlet door including a flow regulation feature.

13. The gas turbine engine of claim 12, wherein the flow regulation feature is an articulating door, and the articulating door is controllably coupled to an engine controller such that the engine controller is operable to control a flow of air through said cooling air outlet.

14. A method for generating cooled cooling air in a gas turbine engine comprising:
withdrawing fan bypass duct air from a fan bypass duct and withdrawing bleed air from a primary flowpath in an engine core;
providing the fan bypass air and the bleed air to a heat exchanger in an engine bifurcation via ducting;
transferring heat from said bleed air to said fan bypass air in said heat exchanger; and
providing the cooled bleed air to at least one gas turbine engine component as cooled cooling air.

15. The method of claim 14, wherein withdrawing fan bypass duct air from a fan bypass duct comprises modifying a position of at least one articulating door at one of an inlet of said ducting and an outlet of said ducting.

16. The method of claim 14, further comprising exhausting heated fan bypass duct air from said heat exchanger into one of an aft portion of the fan bypass duct and an ambient atmosphere downstream of said fan bypass duct.

17. The method of claim 16, wherein exhausting said heated fan bypass duct air includes passing said heated fan bypass air through an exhaust nozzle, thereby generating thrust.

18. The method of claim 14, wherein transferring heat from said bleed air to said fan bypass air in said heat exchanger comprises passing said bleed air through a plurality of pipes in said heat exchanger, and passing said fan bypass air across said pipes in said heat exchanger.

19. The method of claim 14, wherein providing the fan bypass air and the bleed air to a heat exchanger in an engine bifurcation via ducting further comprises providing the fan bypass air and the bleed air to at least two heat exchangers in the engine bifurcation.
